(19) United States
(12) Patent Application Publication
(10) Pub. No.: US 2025/0268243 A1
(43) Pub. Date: Aug. 28, 2025

(54) TRENCHLESS, ARTICULATING RODENT-BLOCKING IMPLEMENT FOR SEWER CLEANOUTS

(71) Applicant: David Schuelke, Park City, UT (US)

(72) Inventor: David Schuelke, Park City, UT (US)

(21) Appl. No.: 18/584,754

(22) Filed: Feb. 22, 2024

(51) Int. Cl. A01M 29/30; E03F 7/06

(52) U.S. Cl. CPC A01M 29/30; E03F 7/06

(57) ABSTRACT

A trenchless, rodent-blocking apparatus for creating a one-way check valve, or gate, within for a sewer cleanout operable to permit through flow of sewer down the sewer pipe but prevent rodent entry up the sewer pipe. The disclosed assembly inserts vertically into a sewer cleanout without requiring excavation or demolition.

### BACKGROUND

### Field of the Invention

This invention relates to rodent abatement and more particularly relates to An apparatus operable to prevent entry of rodents into a pipe system such as a sewer line.

### Description of the Related Art

Rodents commonly enter residences and commercial building through sewer lines. Rodents are then able to gain access to toilets, sinks and drains within the home or commercial building, which are usually unrestricted, often comprising only a P-trap to prevent access. These rodents are often seeking food, warmer environments, or nesting opportunities.

Rats in sewage systems give rise to serious sanitary problems in large cities or urban areas. The sanitary problems arise from the rodents' access to residential buildings, tenements, office buildings, and shops through the sewage systems, primarily through the toilets.

Laboratory investigations, trials and also field investigations have shown that rats are able to move completely freely along sewer lines, both vertically and horizontally running pipes. In the case of vertical pipes, so-called downpipes or downspouts, rats are able to climb easily to heights of several floors in the case of apartment buildings, provided that the internal diameter of the pipes is not greater than 110 mm, which is the pipe diameter usually used in downpipes which is used in the apartment block.

Rodents, including mice and rats, can destroy articles of food, books, furnishing, and homes. These rodents carry disease and infestations which may result in closure of commercial businesses and sickening of residents in residential settings. Rodents' gnawing, urine and feces can poison humans or infect humans with any of a plurality of deadly viruses, including hantavirus.

Traditional means of blocking sewer lines are almost non-existent and usually require excavation only to fail within months. These prevention devices rust or wear and lodge open or closed, and usually are placed only where not easily accessed by property owners, manager or maintenance personnel. Typically, rodent prevention devices inserted into sewer pipes require excavation and demolition of existing construction, such as driveways under which the sewer line travels. Apparati which insert vertically into existing cleanouts are unknown in the art.

Hinged grid or screens are known, but not efficient. Such prevention devices also pose a danger if lodged closed of blocking sewage.

Sewer line cleanouts are known in the art and provide means for accessing a sewer line without having to excavate, but there exists no efficient means of blocking rodent entry at clean out junction points. Several attempts have been made to prevent migration of rodents through sewer lines which are not efficient.

Attempting to rid a building of rodents can be an expensive, labor intensive and time-consuming exercise and is not always possible given open sewer lines. Other traditional methods of dealing with rodent invasions involves the use of poisoned baits (rodenticides) that contain anticoagulants, such as warfarin, pival and chlorophacinone. Such baits are nevertheless toxic and are therefore undesirable for use in the home, particularly those in which children and pets reside and which may be inadvertently exposed to these poisons. These methods do not prevent entry in the first place through sewer lines. In addition, poisoned mice often die in inaccessible locations thereby resulting in an unpleasant odor upon death of the mouse.

The purpose of the present invention is to provide a rodent barrier device that can be installed in existing sewer lines. The device is intended to effectively block the passage of the common sewer rat. The characteristic features of the present invention are stated in the following claims below.

While recognizing the shortcomings of prior art, the present invention overcomes these deficiencies inherent in the art is therefore desirable.

### SUMMARY

From the foregoing discussion, it should be apparent that a need exists for a rodent-blocking apparatus operable with a sewer clean out. Accordingly, the present invention has been developed to provide a rodent-blocking apparatus operable to prevent through passage of a rodent through a sewer pipe, the apparatus comprising: a disc-shaped gate hingedly connected to a mandible; a mandible comprising an arcuate surface having a distal end affixed to the gate and a proximal end; an arcuate beam affixed to the mandible operable to brace the mandible against an interior surface of one of a pipe and a cleanout; a lower guide rod hingedly affixed to the proximal end of the mandible; and a cup affixed to proximal end of the guide rod.

The gate may comprise a convex surface. The mandible may comprise two sidewalls. In other embodiments, the gate further comprises a cylindrical knuckle. The rodent-blocking apparatus may further comprise a plurality of flanges circumscribing a guide rod, the flanges having a diameter less than an interior diameter of the pipe.

A rodent-blocking apparatus operable to prevent through passage of a rodent through a sewer pipe, the apparatus comprising: a disc-shaped gate hingedly connected to a mandible; a mandible comprising an arcuate surface having a distal end affixed to the gate and a proximal end, the mandible defining a hollow interior recess between two sidewalls; an arcuate beam affixed to the mandible operable to brace the mandible against an interior surface of one of a pipe and a cleanout; a lower guide rod hingedly affixed to the proximal end of the mandible; and a cup affixed to proximal end of the guide rod, wherein the cup is affixed eccentrically to the lower guide rod.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1A is an isometric perspective view illustrating one embodiment of a rodent-blocking apparatus in accordance with the present invention;

FIG. 1B is an isometric perspective view illustrating one embodiment of a rodent-blocking apparatus in accordance with the present invention;

FIG. 2 is an upper perspective view illustrating one embodiment of a rodent-blocking apparatus in accordance with the present invention;

FIG. 3 is an environmental perspective view illustrating one embodiment of a rodent-blocking apparatus in accordance with the present invention;

FIG. 4 is a side perspective view illustrating one embodiment of a component of rodent-blocking apparatus in accordance with the present invention;

FIG. 5 is an environmental perspective view illustrating one embodiment of a rodent-blocking apparatus in accordance with the present invention; and

FIG. 6 is a sectioned, environmental perspective view illustrating one embodiment of a rodent-blocking apparatus in accordance with the present invention.

### DETAILED DESCRIPTION

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

It is an object of the present invention to provide a vertically inlaid, rodent-blocking apparatus operable with a sewer ground cleanout which prevents entry of rodents through sewer pipes into buildings. It is an object of the present invention to provide a vertically insertable rodent prevention device for sewer cleanouts which does not require excavation and demolition of existing construction, such as driveways under which the sewer lines often travel.

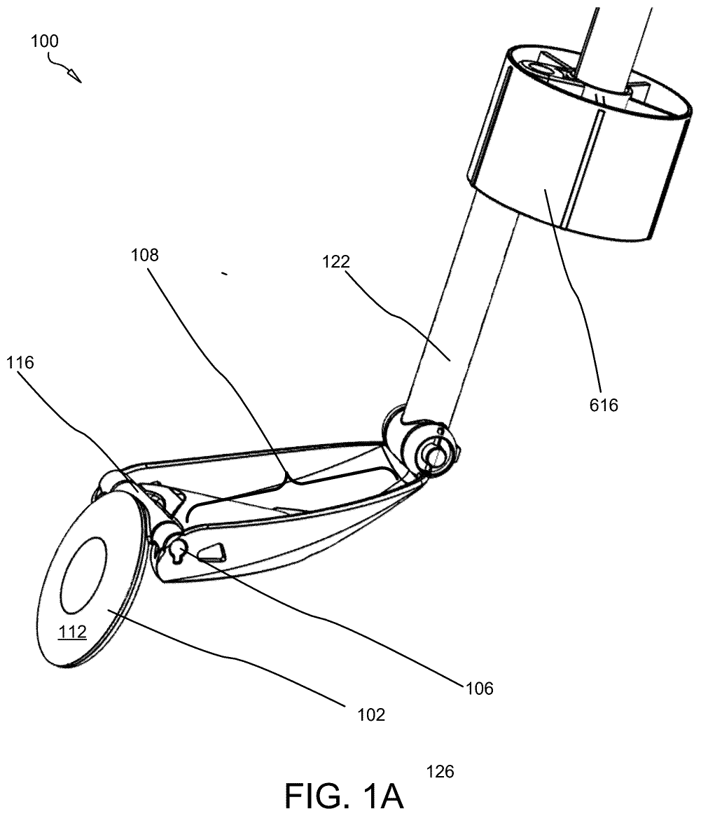

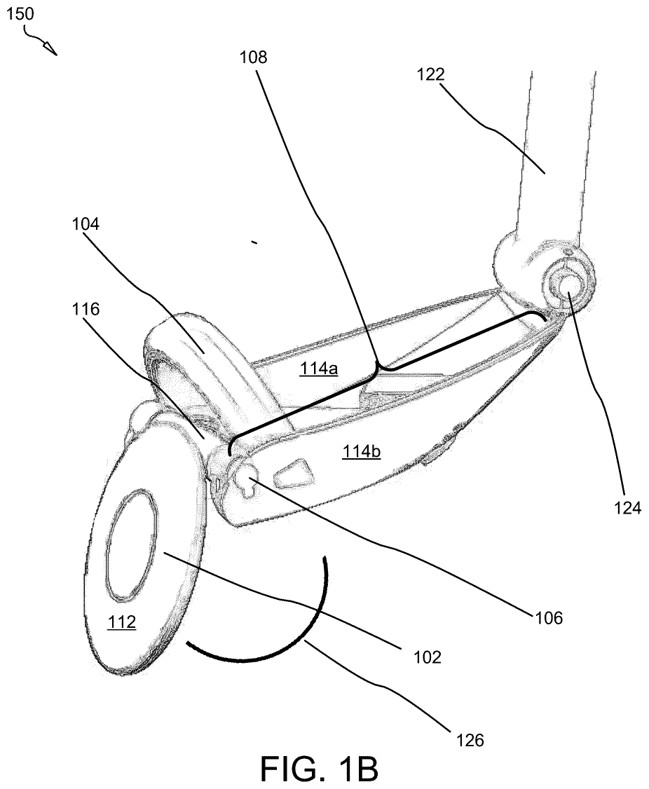

FIGS. 1A-1B are isometric perspective views illustrating embodiments of a rodent-blocking apparatus 100, 150 in accordance with the present invention.

In the apparatus 100 is inserted vertically into a sewer cleanout. The apparatus 100 is operable to create a one-way check valve, or one-way gate, within the sewer line 602 at a T-shaped or Y-shaped junction within fittings commonly used in sewer piping systems to create clean outs 604. The gate 102 may comprise a convex or domed top surface 112 functional to swing into or against a leeward direction of sewage travel.

The apparatus 100 comprises a disc-shaped gate 102 hinged affixed to a distal end of a mandible 108. The mandible 108 may comprise a shaft or rod hinged connected to other components at both distal and proximal end. In the shown embodiments, the mandible 108 comprises a cup-shaped, concave member defining a hollow interior recess 204 upwardly facing.

The mandible 108 may comprise a convex, or rounded, lower surface 110 adapted to contour or partially contour a curve inherent in Y-shaped fittings. The mandible 108 comprises, or incorporates, an arcuate protuberance 104 (i.e., brace 104) which juts upwardly from the mandible 108 and contours an inner surface of Y-shaped fitting or clean out 604. The arcuate protuberance 104 may be affixed to the mandible 108 or may be formed therewith as a single integrated piece.

The mandible 108 may comprise two sidewalls 114a-b which operate as leaves, prongs, or bearings, allowing limited rotation of the gate 102 between them along an axis of rotation perpendicular to the length of the sidewalls 114a-b.

The gate 102 may comprise a cylindrical knuckle 116 which rotates axially between the sidewalls 114a-b. The knuckle 116 and the sidewalls 114a-b together may form an H-shaped barrel hinge. The mandible 108 articulates on the guide rod 122 and/or gate 102.

In various embodiments, the gate 102 swings toward or away from the arcuate beam 104 and is stopped by the sidewalls 114 from swinging beyond or within a predetermined angle 126 toward the mandible 108. The predetermined angle 126 may be between 70 and 130 degrees.

The brace 104 comprises a polymeric arch, or arcuate beam, operable to dispose within a sewer line and brace the mandible 108 against a lower surface of the sewer line 602 by bracing the apparatus 100 against a top surface of the sewer line 602 (using the arcuate beam 104 to inhibit upward mobility of the apparatus 100 within the sewer pipe 602.

A proximal end of the mandible 108 is hinged connected to a lower guide rod 122. The mandible may taper, or have a frustoconical shape, toward the proximal end joining with the lower guide rod 122. A joint 124 may interconnect the mandible 108 and the lower guide rod 122.

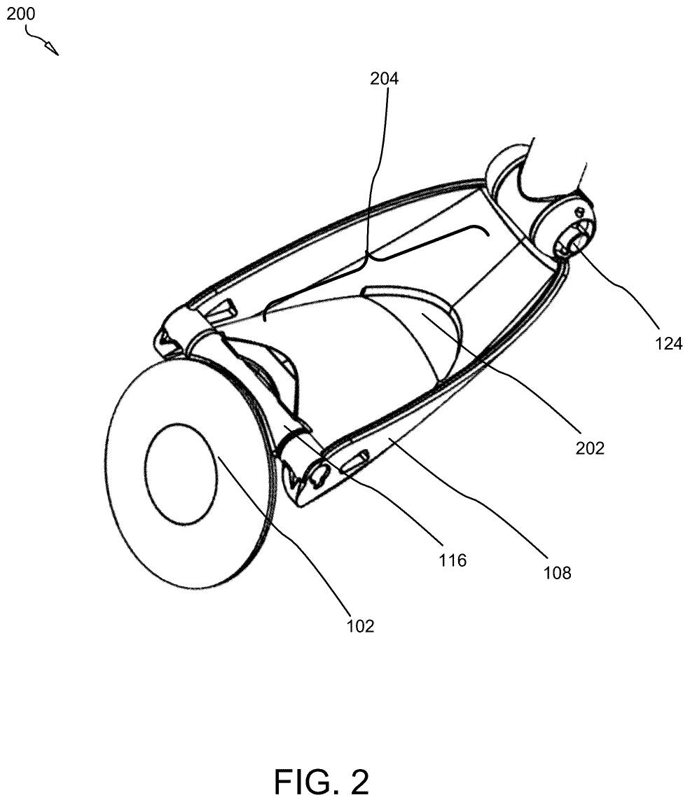

FIG. 2 is an upper perspective view illustrating one embodiment of a rodent-blocking apparatus 200 in accordance with the present invention.

In various embodiments, a lower surface of the mandible 108 comprises a shoe 202 which juts upwardly from the lower surface of the mandible within the recess 204 and defines an semi-circular cavity adapted to receive and partially envelop a distal edge of the gate 102 when the apparatus 200 is in a closed position.

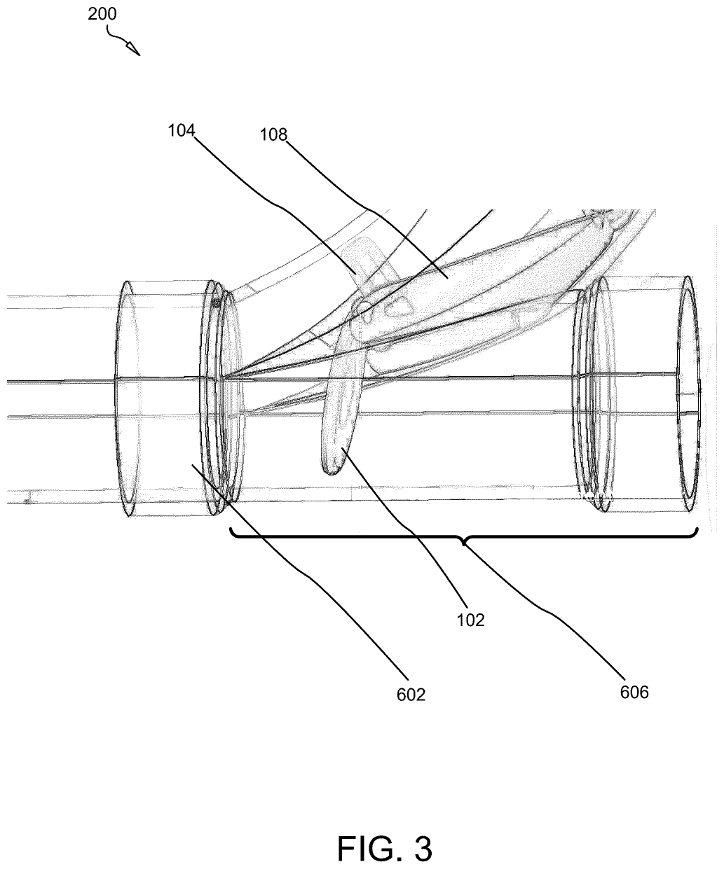

FIG. 3 is an environmental perspective view illustrating one embodiment of a rodent-blocking apparatus 300 in accordance with the present invention.

The apparatus 300 disposes within the Y-shaped fitting 606 as shown. The apparatus 300 inserts vertically into the cleanout and is pushed downwardly until the gate 102 falls into place in obstruction of through passage of sewage and rodents.

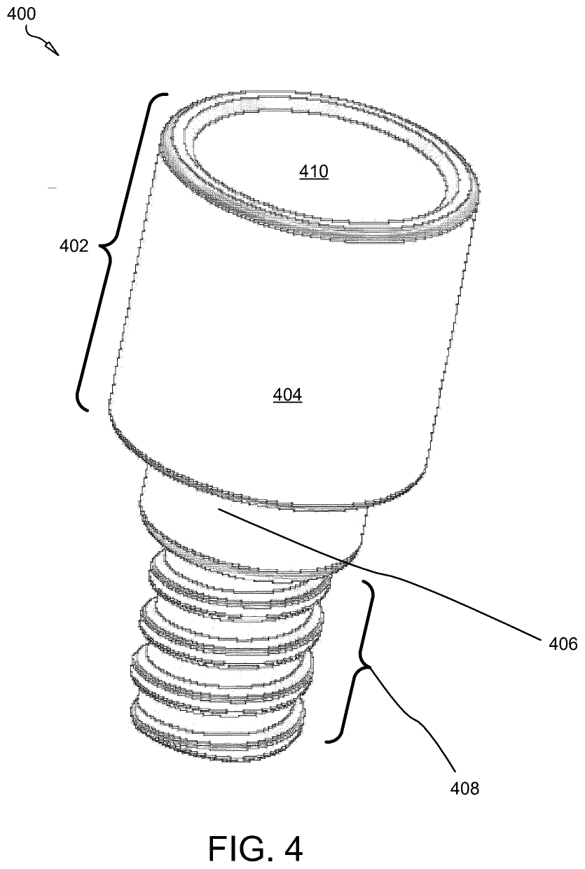

FIG. 4 is a side perspective view illustrating one embodiment of a component of rodent-blocking apparatus 400 in accordance with the present invention.

The component 400 comprises an end cap of a guide rod 614. The guide rod 614 is surrounded by a flange 616 which fits snugly within the cleanout 604. The diameter of the flange 616 is less than an inner diameter of the pipe 602 and/or cleanout 604 and/or Y-shaped fitting.

The end cap 400 may comprise a cylindrical body 402 defining a hollow interior recess 410 which may be threaded. A medial stem 406 may, or may not, position inferiorly to the cylindrical body 402. A lower stem 408 with male threading position inferiorly to the cylindrical body 102.

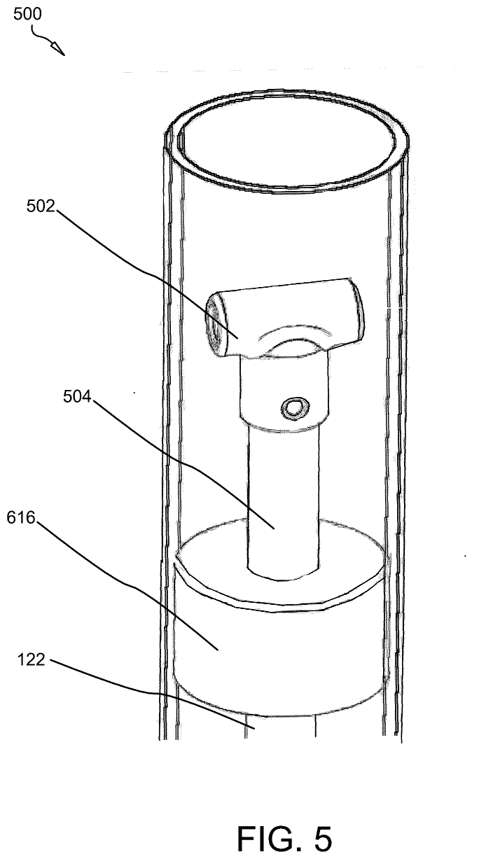

FIG. 5 is an environmental perspective view illustrating one embodiment of a rodent-blocking apparatus 500 in accordance with the present invention.

In various embodiments, one or more flanges circumscribe the guide rod 122 or the a superior guide rod 504. The apparatus 500 may comprise a plurality of superior guide rods all connected in parallel which are detachable from the apparatus 500 to facilitate adjustment of the height of the apparatus and depth the apparatus may be inserted into a cleanout 604.

The uppermost guide rod 504 may comprise a handle 502 as shown. In various embodiments, the handle 502 may be rotated axially to lock the apparatus 500 into place within the pipe 602 using a friction fit.

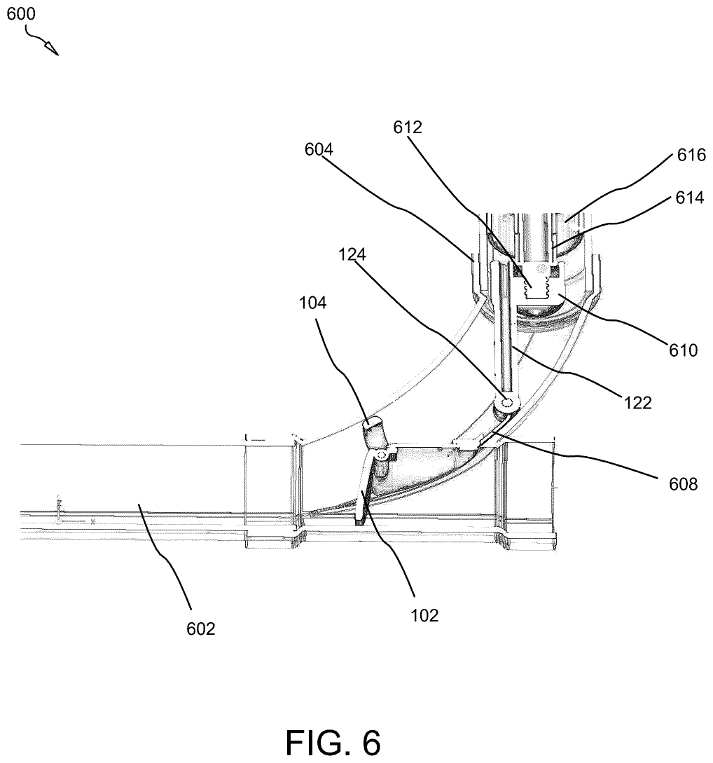

FIG. 6 is a sectioned, environmental perspective view illustrating one embodiment of a rodent-blocking apparatus in accordance with the present invention.

In some embodiments, a medial components 608 interconnects the guide rod 122 and the mandible 108. The medial component may have an arcuate or planar bottom surface and may be hingedly connected to the guide rod 122.

In various embodiments, the apparatus 600 comprises a cup 610 affixed to the lower guide rod 122. In some embodiments, the cup 610 comprises female threading. The guide rod 122 may be affixed eccentrically to the cup 610.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A rodent-blocking apparatus operable to prevent through passage of a rodent through a sewer pipe, the apparatus comprising:
a disc-shaped gate hingedly connected to a mandible;
a mandible comprising an arcuate surface having a distal end affixed to the gate and a proximal end;
an arcuate beam affixed to the mandible operable to brace the mandible against an interior surface of one of a pipe and a cleanout;
a lower guide rod hingedly affixed to the proximal end of the mandible; and
a cup affixed to proximal end of the guide rod.

2. The rodent-blocking apparatus of claim 1, wherein the gate comprises a convex surface.

3. The rodent-blocking apparatus of claim 1, wherein the mandible comprises two sidewalls.

4. The rodent-blocking apparatus of claim 1, wherein the gate further comprises a cylindrical knuckle.

5. The rodent-blocking apparatus of claim 1, further comprising a plurality of flanges circumscribing a guide rod, the flanges having a diameter less than an interior diameter of the pipe.

6. A rodent-blocking apparatus operable to prevent through passage of a rodent through a sewer pipe, the apparatus comprising:
a disc-shaped gate hingedly connected to a mandible;
a mandible comprising an arcuate surface having a distal end affixed to the gate and a proximal end, the mandible defining a hollow interior recess between two sidewalls;
an arcuate beam affixed to the mandible operable to brace the mandible against an interior surface of one of a pipe and a cleanout;
a lower guide rod hingedly affixed to the proximal end of the mandible; and
a cup affixed to proximal end of the guide rod, wherein the cup is affixed eccentrically to the lower guide rod.
